(19) United States
(12) Patent Application Publication
(10) Pub. No.: US 2016/0307266 A1
(43) Pub. Date: Oct. 20, 2016

(54) SYSTEM AND METHOD FOR MATCHING IN SOCIAL-NETWORKING PLATFORM

(71) Applicant: Kevin Hwading Chu, Houston, TX (US)

(72) Inventor: Kevin Hwading Chu, Houston, TX (US)

(21) Appl. No.: 14/688,264

(22) Filed: Apr. 16, 2015

(51) Int. Cl. G06Q 30/08; G06Q 50/00; G06Q 30/02

(52) U.S. Cl. CPC G06Q 30/08; G06Q 30/0269; G06Q 50/01

(57) ABSTRACT

A method for matching in a social-networking system. The method includes obtaining a first criteria from a first user, displaying, on the social-network, a first request that corresponds to the first criteria, receiving first bids from second users who satisfy the first request, filtering the first bids to a first predetermined number, displaying, to the first user, profiles associated with remaining second users, accepting, from among the remaining second users, a selected second user selected by the first user, creating a mapping between the first user and the selected second user and a mapping between the first user and each of eliminated second users, and matching the first user and the selected second user.

### BACKGROUND

Sharing economy is a social-economic system built around the sharing of human and physical resources. Social-networking systems provide the foundation to a sharing economy. Social-networking systems provide an avenue for users to connect with one another. Social-networking systems that better match users with their respective needs provide enhanced user experience. Social-networking systems that enable users to meet their various and differing needs provide enhanced user experience. Social-networking systems that engage users and acquire specific information from users provide enhanced user experience. Monetization of social-networking systems is increased when user experience is enhanced.

### SUMMARY

In general, in one aspect, one or more embodiments disclosed herein relate to a social-networking system comprising a processor configured to: obtain a first criteria from a first user, display, on the social-networking system, a first request that corresponds to the first criteria, receive first bids from second users who satisfy the first request, apply a filter to the first bids, eliminate a subset of the second users according to the filter, display, to the first user, profiles associated with remaining second users, request a second criteria from the first user, display, to the remaining second users, a second request that corresponds to the second criteria, receive second bids from the remaining second users who satisfy the second criteria, accept, from among the remaining second users, a selected second user selected by the first user, and match the first user and the selected second user; and a database configured to store a mapping between the first user and the selected second user and a mapping between the first user and each of eliminated second users.

In another aspect, one or more embodiments disclosed herein relate to a method for matching in a social-networking system comprising: obtaining a first criteria from a first user; displaying, on the social-network, a first request that corresponds to the first criteria; receiving first bids from second users who satisfy the first request; filtering the first bids to a first predetermined number; displaying, to the first user, profiles associated with remaining second users; accepting, from among the remaining second users, a selected second user selected by the first user; storing a mapping between the first user and the selected second user and a mapping between the first user and each of eliminated second users; and matching the first user and the selected second user.

In yet another aspect, one or more embodiments disclosed herein relate to a non-transitory computer readable medium comprising computer readable program code, which when executed by a computer processor, enables the computer processor to: obtain a first criteria from a first user; display, to second users, a first request that corresponds to the first criteria; receive first bids from the second users who satisfy the first criteria; filter the first bids to a first predetermined number; obtain a second criteria from the user; display, to remaining second users, a second request that corresponds to the second criteria; receive second bids from the remaining second users; filter the second bids to a second predetermined number; display, to the first user, profiles associated with last second users; accept, from among the last second users, a selected second user selected by the first user; store a mapping between the first user and the selected second user and a mapping between the first user and each of eliminated second users; and match the first user and the selected second user.

Other aspects and advantages of the disclosure will be apparent from the following description and the appended claims.

### BRIEF DESCRIPTION OF DRAWINGS

FIG. 1 shows a social-networking system according to one or more embodiments.

FIG. 2A shows a social-networking system according to one or more embodiments.

FIG. 2B shows a social-networking system according to one or more embodiments.

FIG. 3 shows a method for matching in a social-networking system according to one or more embodiments.

FIG. 4 shows a method for matching in a social-networking system according to one or more embodiments.

FIG. 5 shows a method for matching in a social-networking system according to one or more embodiments.

FIG. 6 shows a method for initiating a social-network session in a social-networking system according to one or more embodiments.

FIG. 7 shows a method for initiating a social-network session in a social-networking system according to one or more embodiments.

### DETAILED DESCRIPTION

Specific embodiments will now be described in detail with reference to the accompanying figures. Like elements in the various figures are denoted by like reference numerals for consistency.

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create a particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

In general, embodiments of the disclosure relate to a social-networking system. One or more embodiments of the disclosure relate to a method for matching in a social-networking system. One or more embodiments of the disclosure relate to a system and method for initiating and monetizing a social-networking session in a social-networking system. One or more embodiments of the disclosure relate to a system and method for open (i.e. public) and/or closed (i.e. private bidding) in a social-networking system. One or more embodiments of the disclosure relate to a method for mapping user behavior in a social-networking system. One or more embodiments of the disclosure relate to a method for targeted advertisement using mappings of user behavior in a social-networking system.

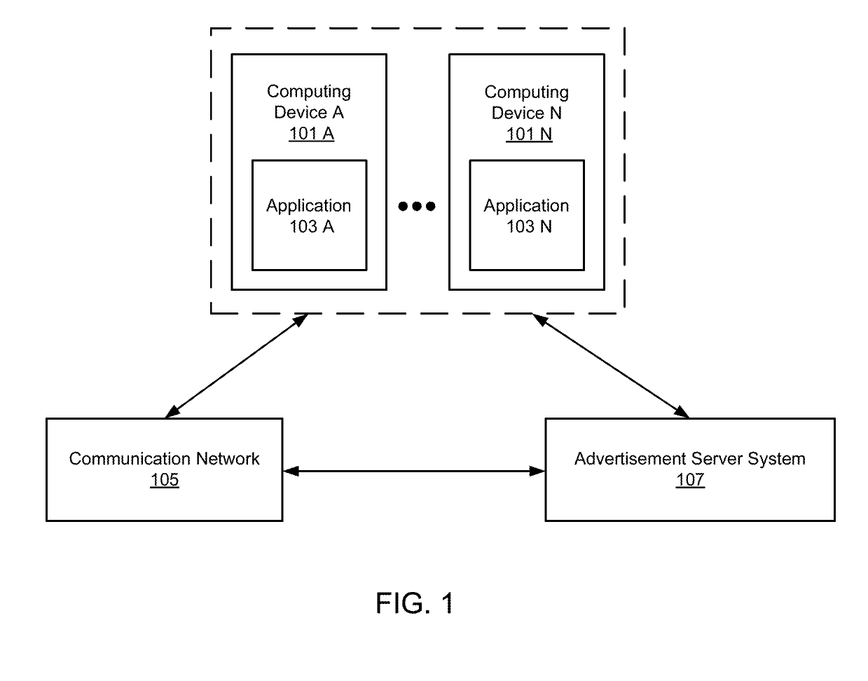

FIG. 1 shows a social-networking system according to one or more embodiments. As shown in FIG. 1, the system has multiple components including one or more computing devices (101A, 101N) each running an application (103A, 103N), a communication network (105), and an advertisement server system (107). As also shown in FIG. 1, various components of the system may communicate directly or indirectly with one another. The communication may be exchange of information, storage of information, etc. The information within the social-networking system described herein may be stored in one or more data structures. Further, any data structure type (e.g., arrays, linked lists, hash tables, etc.) may be used to organize information within the data structure(s) provided that the data structure type(s) maintain the various exchange of information described. Each of these components is described below.

In one or more embodiments of the disclosure, each computing device (101A, 101N) may be a desktop personal computer (PC), a laptop, a tablet computer, an electronic reader (e-reader), a cable box, a kiosk, a smart phone, a server, a mainframe, a personal digital assistant (PDA), or any other type of hardware device. Each device may include a processor, persistent storage, and a memory to execute the one or more applications (103 A, 103 N). The device may communicate (directly or indirectly) with the communication network (105) and/or with the advertisement server system (107) using any wired and/or wireless (e.g., wifi, cellular, etc.) connections.

In one or more embodiments of the disclosure, the computing device (101A, 101N) may also include one or more input device(s) (not shown), such as a touchscreen, keyboard, mouse, microphone, touchpad, electronic pen, or any other type of input device. Further, the computing device (101A, 101N) may include one or more output device(s) (not shown), such as a screen (e.g., a liquid crystal display (LCD), a plasma display, touchscreen, cathode ray tube (CRT) monitor, projector, or other display device, a printer, external storage, or any other output device. One or more of the output device(s) may be the same or different from the input device(s). Many different types of computing systems exist, and the aforementioned input and output device(s) may take other forms.

In one or more embodiments of the disclosure, the application (103 A, 103N) may be a software application of any type (e.g., operating system, messaging application, social media application, game, word processing application, web browser, etc.). The application may be implemented to include one or more advertisement placements. An advertisement placement is a predefined space in an application used to display one or more native or non-native online advertisements. For example, the advertisement placement may be a specific location within the user interface of an application. In another example, the advertisement placement may be associated with a feature in the application, e.g., in a news feed, a user profile message board, a message feed, or a stream. In one or more embodiments of the disclosure, the stream is a presentation of, list of, or other organization of content within application (103A, 103N). The stream may include both content and ads (which may include native ads).

In one or more embodiments of the disclosure, the application (103A, 103N) may be deployed along with a software development kit (SDK). During the execution of the application (103A, 103N), the SDK may issue a fill request to the advertisement server system (107). The fill request is effectively a request for advertisement content from the advertisement server system (107). In order to generate an advertisement and populate the advertisement placement. The fill request may take the form of a uniform resource locator (URL). Moreover, the fill request may include one or more parameters including an advertisement placement ID, a device ID, the version of the SDK, one or more keywords, a type of content (e.g., sports, cars, pets, vacations, clothes, etc.) displayed around the advertisement placement, a type of connection (e.g., wifi, cellular, etc.) between the device (101A, 103N) and the advertisement server system (107), etc.

In one or more embodiments of the disclosure, one or more partners and/or one or more advertisers may provide the advertisement content to the advertisement server system (107). Different partners and advertisers may provide advertisement content in different formats. Further, the advertisement content provided by the one or more partners and the one or more advertisers may be in a format that is different from the format of the advertisement content required/requested to generate and populate the advertisement placement.

In one or more embodiments of the disclosure, the communication network (105) may be implemented on hardware device that includes a memory and a processor. The communication network (105) is operatively connected to the application (103A, 103N), the advertisement server system 107, and/or an application/server interface (213).

In one or more embodiments of the disclosure, the communication network (105) serves as communication layer that interfaces with the application (103A), the advertisement server system (107), and/or server(s) of the social-networking system.

The communication network (105) may also enable an interface to a Local Area Network (LAN), Wide Area Network (WAN) or the Internet through a variety of connections including, but not limited to, standard telephone lines, LAN or WAN links (e.g., 802.11, T1, T3, 56 kb, X.25, SNA, DECNET), broadband connections (e.g., ISDN, Frame Relay, ATM, Gigabit Ethernet, Ethernet-over-SONET), wireless connections, or some combination of any or all of the above. Connections can also be established using a variety of communication protocols (e.g., TCP/IP, IPX, SPX, NetBIOS, Ethernet, ARCNET, SONET, SDH, Fiber Distributed Data Interface (FDDI), RS232, RS485, IEEE 802.11, IEEE 802.11a, IEEE 802.11b, IEEE 802.11g, CDMA, GSM, WiMax and direct asynchronous connections). One version of the computing device (101A) includes a built-in communication network (105) able to communicate with additional computing devices (101N) via any type and/or form of gateway or tunneling protocol such as Secure Socket Layer (SSL) or Transport Layer Security (TLS), or the Citrix Gateway Protocol manufactured by Citrix Systems, Inc. Versions of the communication network (105) can comprise any one of: a built-in network adapter; a network interface card; a PCMCIA network card; a card bus network adapter; a wireless network adapter; a USB network adapter; a modem; or any other device suitable for interfacing the computing device (101A) to a network capable of communicating and performing the methods and systems described herein.

In one or more embodiments of the disclosure, the advertisement server system (107) may communicate directly with the computing device (101A, 101N) executing the application (103A, 103N) or indirectly with the computing device (101A, 101N) executing the application (103A, 103N) via the communication network (105).

In one or more embodiments of the disclosure, the advertisement server system 107 is a platform that allows real-time bidding (RTB) on advertisement placements by the one or more partners and/or the one or more advertisers. Using an advertisement exchange, advertisers may auction the advertisement placement in the application (103A, 103N) to the highest bidder through a single interface.

In one or more embodiments of the disclosure, the one or more advertisers may include their own advertisement content and provide this advertisement content directly to the advertisement server system.

In one or more embodiments of the disclosure, the advertisement server system (107) may be a part of the social-networking system. In one or more embodiments of the disclosure, the advertisement server system (107) may be hosted and/or maintained by a third-party different from the social-networking system. In one or more embodiments of the disclosure, the advertisement server system (107) may be hosted and/or maintained by a third-party that has contractual agreements with the social-networking system.

Those skilled in the art will appreciate that while FIG. 1 shows a particular system configuration, the disclosure is not limited to the aforementioned system configuration.

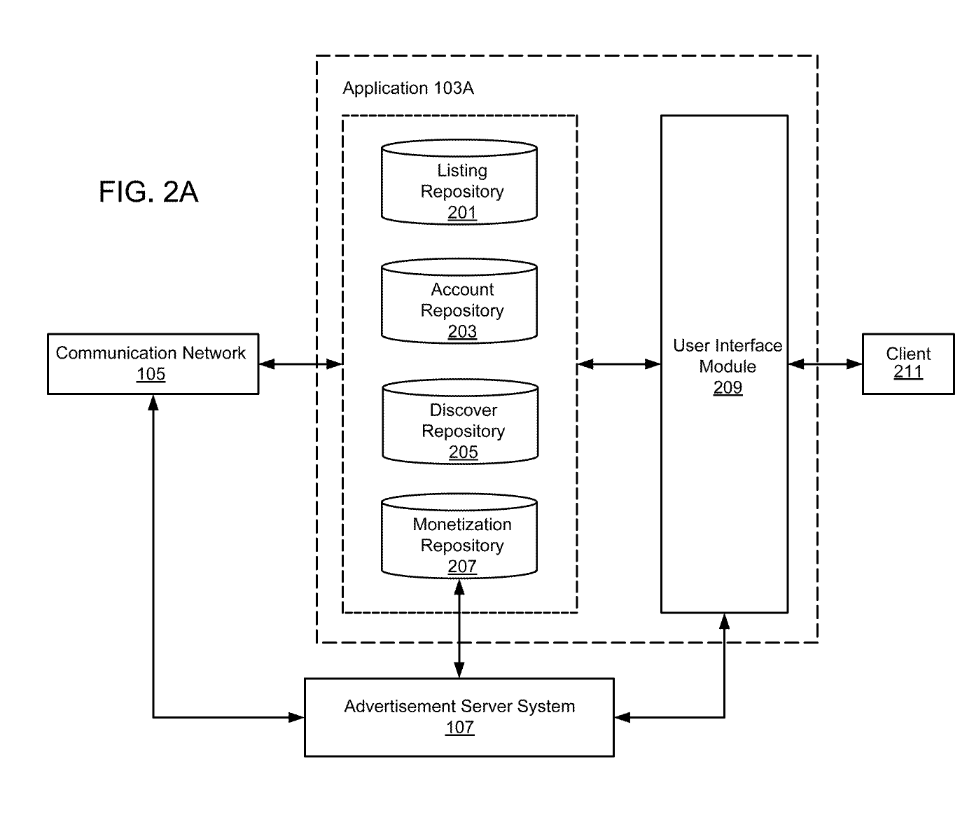

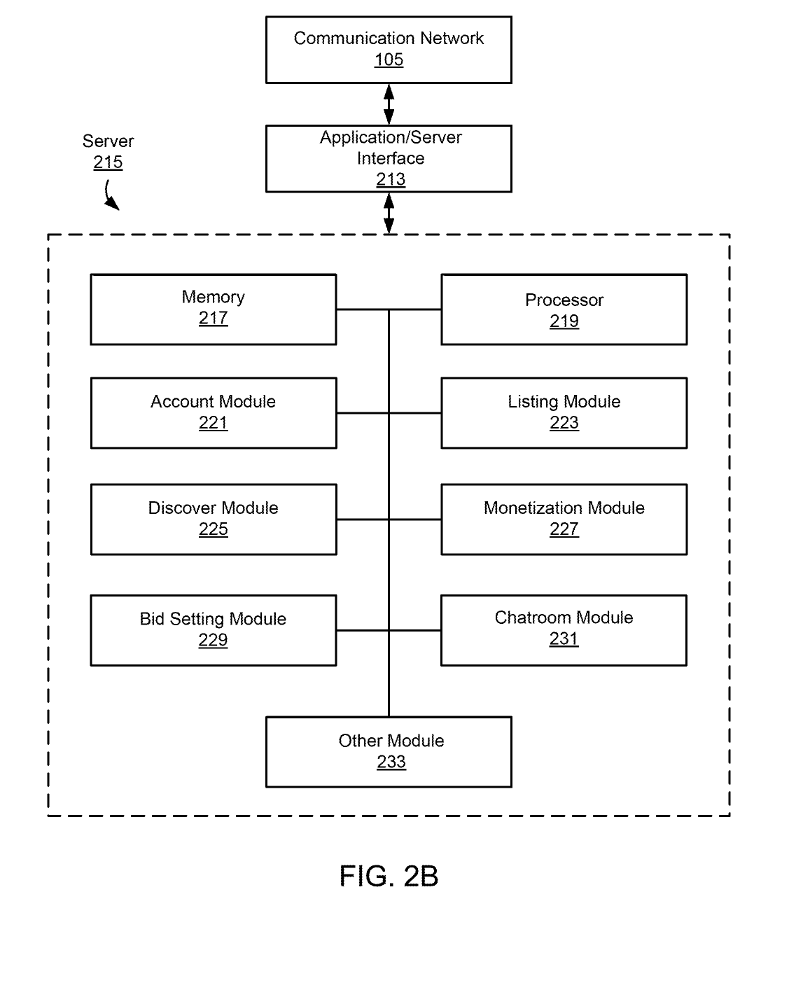

FIG. 2A shows a social-networking system according to one or more embodiments. As mentioned above, components that have already been described will be omitted for the sake of brevity. As shown in FIG. 2A, the system has multiple components including an application (103A), a communication network (105), an advertisement server system (107), and a client (211). Each of these components is described below.

The application (103A) may comprise a listing repository (201), an account repository (203), a discovery repository (205), a monetization repository (207), a user interface module (209), and a client (211) that a user may directly interact with. In one or more embodiments of the disclosure, one or more of the data repositories (listing repository (201), account repository (203), discovery repository (205), monetization repository (207)) is a database and/or storage service residing on one or more servers. In the case that the data repositories are physically resided on one or more servers separate from the computing device (101A), the repositories within the application (103A) may communicate directly or indirectly with their respective repositories on the one or more servers. In one or more embodiments of the disclosure, the data repositories may reside on the computing device (101A) executing the application (103A).

The listing repository (201) may comprise a list of requests submitted by users of a social-networking system. The list of requests may be static or may be dynamic. That is, requests may be removed when they are filled; or, they may be displayed and regenerated after a predetermined period of time. The nature of the request is not limited. The request may be, for example, “Please help me deliver documents from location A to location B.” The request may be, for example, “Please tutor me algebra every week from 5:00 PM to 6:00 PM.” The request may be, for example, “Please drive me from location A to location B.” The request may be, for example, “Please translate this document from German to English.” The request may be, for example, “Please help me create a choreography for a dance performance.” The request may be, for example, “I need five temporary actors with these attributes.” The attributes may a user social-networking system rating, location, hourly rate, experience, educational attainment, etc. The request may be, for example, “I need a DJ to host a party next Sunday from 10:00 PM to 2:00 AM.” The request may be, for example, “I need a room today from 10:00 PM to 11:00 PM that can host 10 people.”

The account repository (203) may comprise information of the user in a social-networking system. The information of the user may be, e.g., name, age, gender, educational attainment, language, race, hourly rate, skill set, annual income, location, amount of time to run 100 meters, user social-networking system rating, etc. The account repository (203) is not limited to storing user information. The account repository (203) may be an organization account. The account repository (203) may be an asset account. That is, the “users” within the social-networking system need not be individual users, but may be an organization or an asset. In the case where the account repository (203) is an organization, the account repository (203) may store information including, for example, the size of the organization, the nature of the organization (i.e., industry), length of time as the organization, location of the organization, etc. In the case where the account repository (203) is an asset, the account repository (203) may store information including, for example, the size of a room, the number of office buildings available, the number of parking spaces available, the availability of a private jet for the next month, etc.

The discovery repository (205) may comprise a physical location of the user and may recommend requests near the physical location of the user that can be filled by the user. The discovery repository (205) may be interactive or may be passive (i.e., processing in the background). For example, in a case where the discovery repository (205) is interactive, the discovery repository (205) may prompt the user “We think you are able to deliver a sandwich from location A to location B for Jim; would you like to accept the task?” For example, in a case where the discovery repository (205) is passive, the user may have the option to view recommended tasks near the location of the user.

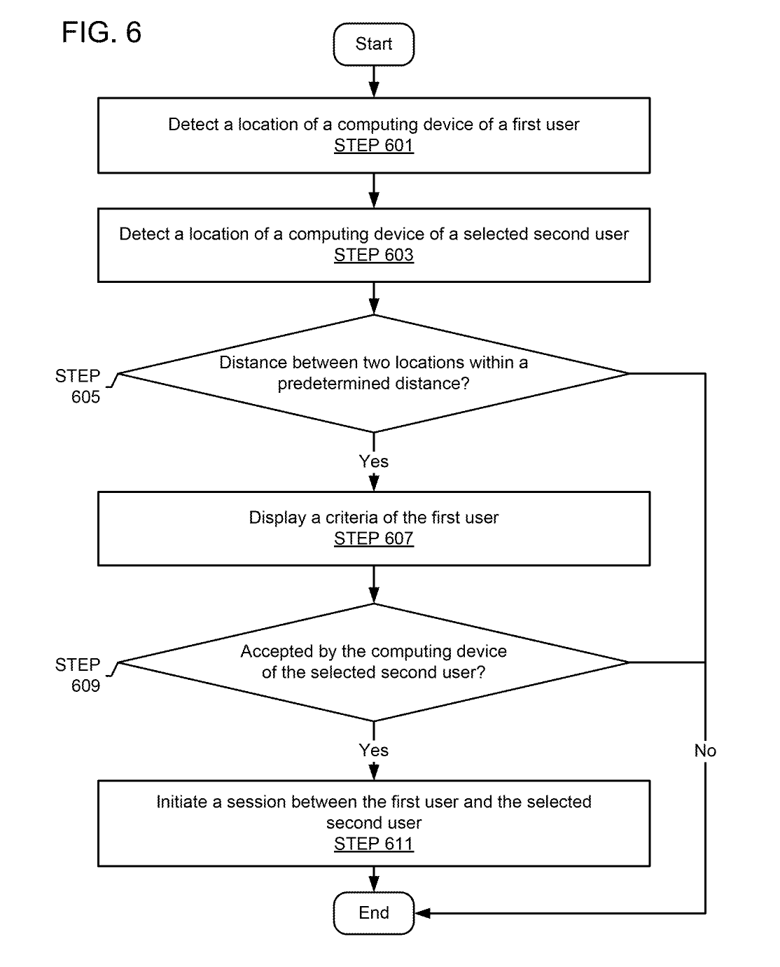

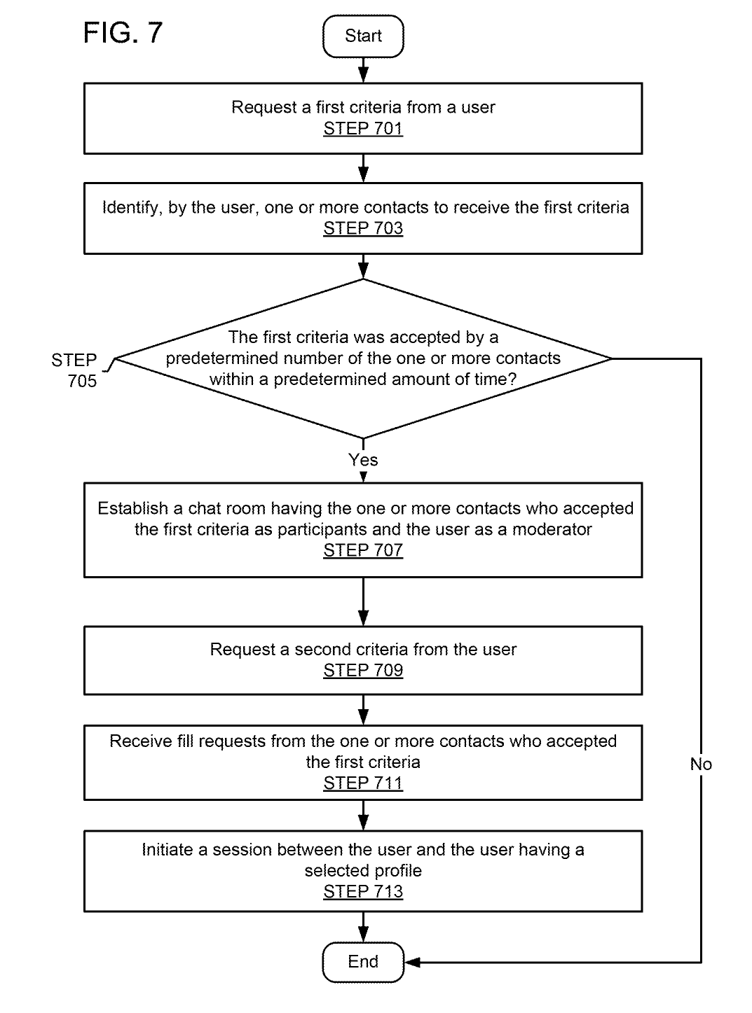

The monetization repository (207) may comprise a location detector that initiates a monetization activity when a social-networking session is initiated. Details pertaining to the monetization repository (207) are described in detail in reference to FIGS. 6 and 7.

One of ordinary skill in the art would appreciate that the repositories available within the application (103A) are not limited to those discussed above.

In one or more embodiments of the disclosure, a mapping repository may be included to store mappings of users of the social-networking system. That is, when user A and user B have been connected at least once, the mapping repository may issue a reminder to user A that a new request issued by user A is the same as, or similar, to a previously-completed task performed by user B for user A. The social-networking system may then ask user A whether to issue the request directly to user B.

In one or more embodiments of the disclosure, a blacklist repository may be included to store certain users that the user does not wish to engage in connection with. In one or more embodiments of the disclosure, a whitelist repository may be included to store certain users that the user wish to engage in connection with. The whitelist may display whitelisted users to the user as priorities. The whitelisted users may have relatively high relationship scores (to be explained below) with the user. The whitelisted users may be displayed to the user different from other users in that the user name may be, e.g., bolded, italicized, underlined, colored, flashing, flashing at a varying frequency, changing in font size, etc. In one or more embodiments, a relationship score may be given to a pair of users. In one or more embodiments, a relationship score may be given to a pair of users for a category of request.

In one or more embodiments of the disclosure, a chat room repository may be included to store information pertaining to conversions between/among users. The chat room repository may comprise “hotkeys” enabling a user to issue a previously-issued request to other user(s) in the chat room. The chat room repository may comprise emoticons relating to the specific requests issued by the user.

In one or more embodiments of the disclosure, a payment repository may be included to enable a user to make payments using the social-network system. For instance, upon completion of a certain task listed in the listing repository (201), a user may decide to pay another user using the payment repository. The payment repository may store information including, e.g., credit card number, bank account number, gift card number, pre-paid card number, coupon number etc.

In one or more embodiments of the disclosure, a live feed repository may be included to store and display information that is occurring now or has happened within a predetermined time. For example, the live feed repository may display to the user the information “Bob has just helped Alice move from Houston to Sugarland.” The live feed repository may provide the user an opportunity to engage with Bob and Alice.

In one or more embodiments of the disclosure, a user interface module (209) is provided. The user interface module (209) aggregates the repositories associated with the application (103A) and compiles the repositories into a presentable format.

In one or more embodiments of the disclosure, a client (211) is provided. The client (211) is a front end that users see and interact with. The client (211) enables displaying of information of the application (103A) to a variety of screen sizes and resolutions. One of ordinary skill in the art would appreciate that the client (211) is not limited to a specific platform, browser, operating system, device, etc. The client (211) engages users of the social-networking system and is the platform that users directly interact with.

As shown in FIG. 2A, the communication network is configured to communicate with the application (103A) and the advertisement server system (107). The communication may be request for information. The communication may be exchange of information. The communication may be storage of information. The communication may be submission of information.

As shown in FIG. 2A, the advertisement server system (107) is configured to communicate with the monetization repository (207) of the application (103A). Although the advertisement server system (107) is shown to be communicating with the monetization repository (207), in one or more embodiments of the disclosure, the advertisement server system (107) may also communicate with a mapping repository, a chat room repository, etc. Upon identifying key information (e.g., keyword search, request submission history by the user, etc.), the advertisement server system may forward information to one or more partners or one or more advertisers with an advertisement fill request. The one or more partners or the one or more advertisers may then bid on the advertisement. Once an advertisement has been selected, the advertisement is then forwarded to the user interface module (209). The interface module (209) aggregates the information from the various repositories and the advertisement(s) from the advertisement server system (107). A user of the social-networking system is then able to see the information of the various repositories and the advertisement(s) via the client (211).

In one or more embodiments of the disclosure, the client (211) may directly communicate with the advertisement server system (107). For example, upon detecting that the user has searched a particular key term, the advertisement server system (107) may examine the mapping repository and the mapping repository and generate advertisements to users of interests. For example, the advertisement server system 107 just detected that user A has searched the term “Office Space 4:00 PM-6:00 PM for 6 people.” The mapping repository may or may not comprise information on a user B meeting the specified term. In the event that user B meets the term, user B may be served an advertisement or a recommendation to help satisfy the request of user A. In one or more embodiments of the disclosure, the advertisement server system (107) may solicit advertisements from the one or more partners and the one or more advertisers to advertise to user A. Examples of advertisements served to user A may include, but is not limited to, office space, space availability for 6 people or more, rooms empty during 4:00 PM-6:00 PM, etc.

Those skilled in the art will appreciate that while FIG. 2A shows a particular system configuration, the disclosure is not limited to the aforementioned system configuration.

FIG. 2B shows a social-networking system according to one or more embodiments. As mentioned above, components that have already been described will be omitted for the sake of brevity. As shown in FIG. 2B, the system has multiple components including a communication network (105), an application/server interface (213), and a server (215). Each of these components is described below.

The application/server interface (213) is a set of routines, protocols, and tools that enables servers (215) to communicate with the application (103A).

The server (215) may further comprise a memory (217), a processor (219), an account module (221), a listing module (223), a discover module (225), a monetization module (227), a bid setting module (229), a chat room module (231), and other module(s) (233).

In one or more embodiments of the disclosure, the memory (217) may be, for example, random access memory (RAM), cache memory, flash memory, etc.

In one or more embodiments of the disclosure, the processor (219) may be an integrated circuit for processing instructions. For example, the processor (219) may be one or more cores, or micro-cores of a processor.

In one or more embodiments of the disclosure, the account module (221) may comprise information of a user in a social-networking system. The information of the user may be, e.g., name, age, gender, educational attainment, language, race, hourly rate, skill set, annual income, location, amount of time to run 100 meters, user social-networking system rating, etc. The account module (221) is not limited to storing user information. The account module (221) may be an organization account. The account module (221) may be an asset account. That is, the “users” within the social-networking system need not be individual users, but may be an organization or an asset. In the case where the account module (221) is an organization, the account module (221) may store information including, for example, the size of the organization, the nature of the organization (industry), length of time as the organization, location of the organization, etc. In the case where the account module (221) is an asset, the account module (221) may store information including, for example, the size of a room, the number of office buildings available, the number of parking spaces available, the availability of a private jet for the next month, etc.

In one or more embodiments of the disclosure, the listing module (223) may comprise a list of requests submitted by users of a social-networking system. The list of requests may be static or may be dynamic. That is, requests may be removed when they are accepted; or, they may be displayed and regenerated after a predetermined period of time. The nature of the request is not limited. The request may be, for example, “Please help me deliver documents from location A to location B.” The request may be, for example, “Please tutor me algebra every week from 5:00 PM to 6:00 PM.” The request may be, for example, “Please drive me from location A to location B.” The request may be, for example, “Please translate this document from German to English.” The request may be, for example, “Please help me create a choreography for a dance performance.” The request may be, for example, “I need five temporary actors with these attributes.” The request may be, for example, “I need a DJ to host a party next Sunday from 10:00 PM to 2:00 AM.” The request may be, for example, “I need a room today from 10:00 PM to 11:00 PM that can host 10 people.” The request may be, for example, “I need to borrow a tuxedo.”

In one or more embodiments of the disclosure, the discovery module (225) may comprise a physical location of the user and may recommend requests near the physical location of the user that can be filled by the user. The discovery module (225) may be interactive or may be passive (i.e., processing in the background). For example, in a case where the discovery module (225) is interactive, the discovery module (225) may prompt the user “We think you are able to deliver a sandwich from location. A to location B for Jim; would you like to accept the task?” For example, in a case where the discovery module (225) is passive, the user may have the option to view recommended tasks nearby the location of the user.

In one or more embodiments of the disclosure, the monetization module (227) may comprise a location detector that initiates a monetization activity when a social-networking session is initiated. Details pertaining to the monetization module (227) are described in detail in reference to FIGS. 6 and 7.

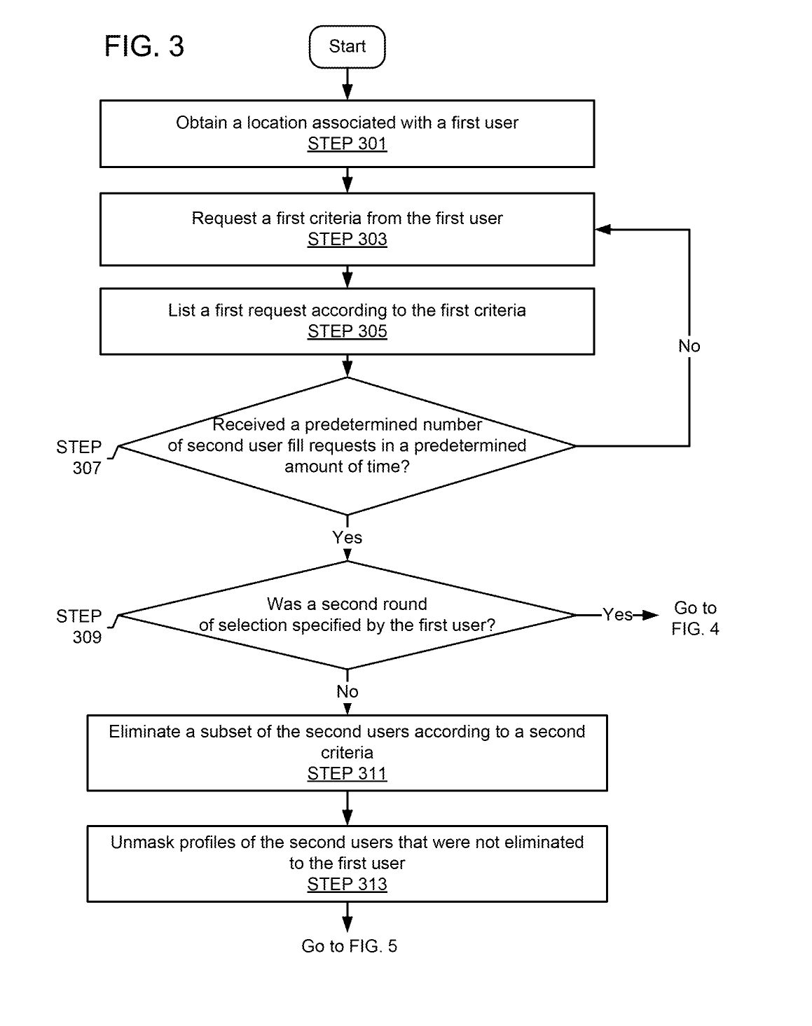

In one or more embodiments of the disclosure, the bid setting module (229) may be a chat room module (231). In one or more embodiments of the disclosure, the bid setting module (229) may enable a user of the social-networking system to submit a request and initiate a bid process for other users to bid on fulfilling the request. For example, the bid setting module (229), upon receiving a request from the user, may list the request on the listing module (223). Upon receiving bids from other users to fulfill the bid, the bid setting module (229) may automatically or manually, or, using a combination thereof to, forward those bids that satisfy the request. The bid setting module (229) may or may not automatically filter and remove certain qualified bids to reduce the number of qualifying bids. The bids are then forwarded to the user, who may or may not initiate another round of bidding for the request. According to one or more embodiments, the bids may be virtual tokens purchased in an-app store. The virtual tokens may enable second users to unlock tasks/requests from first users who are more trustworthy, i.e., have higher ratings. The virtual tokens may enable second users to bid on tasks that would otherwise be off limit to those second users due to, e.g., distance, restrictions set forth by the second user, etc. More details pertaining to the bid setting module (229) as well as the bid process are discussed in association with FIGS. 3-5.

In one or more embodiments of the disclosure, the other module(s) (233) may be a storage (e.g., a hard disk, an optical drive such as a compact disk (CD) drive or digital versatile disk (DVD) drive, a flash memory stick, etc.). In one or more embodiments of the disclosure, the other module(s) may be any module that corresponds to those repositories previously discussed in reference to FIG. 2A. For example, if the social-networking system comprises a blacklist repository, the other module(s) may comprise a corresponding blacklist module. For example, if the social-networking system comprises a payment repository, the other module(s) may comprise a corresponding payment module.

Those skilled in the art will appreciate that while FIG. 2B shows a particular system configuration, the disclosure is not limited to the aforementioned system configuration.

Turning to the flowcharts, while the various steps in the flowcharts are presented and described sequentially, one of ordinary skill will appreciate that some or all of the steps may be executed in different orders, may be combined or omitted, and some or all of the steps may be executed in parallel.

FIG. 3 shows a method for matching in a social-networking system according to one or more embodiments. The method shown in FIG. 3 may be implemented by the server (215).

In Step 301, a location of a first user using the social-networking system may be obtained if the location is relevant to a request to be issued by the first user. The location may be acquired by any known protocol. For example, when a location of the first user is to be obtained, a Location Service Client (LSC) may transmit a location service request carrying a first user bearer identifier of the first user to a Bearer Mapping Function (BMF) through a Gateway Mobile Location Centre (GMLC). After receiving the location service request, the BMF may search for a corresponding Interworking Packet Access Gateway (iPAG) according to the first user bearer identifier, and after obtaining the first user location information from the iPAG, the BMF may return the first user location information to the LSC through the GMLC or may instruct the GMLC to obtain the first user location information from the iPAG.

In Step 303, the first user using the social-networking system may submit or may be requested to submit a first criterion/criteria. The submission may be in the form of strings, numbers, checkboxes, multimedia uploads, etc. The submission may be chosen from a list of requests already put together by the social-networking system.

In Step 305, the social-networking system assesses the validity of the request and, if the request is valid, lists a request according to the first criterion/criteria. If the request is invalid, or if certain parameters of the request ought to be amended, the social-networking system may attempt to correct or prompt the first user to correct the request. If the first user lists a set of first criteria in Step 303, the listing in Step 305 may or may not list each and every one of the first criteria to the second users who are targeted to view the request. Instead, a first sub-criterion of the first criteria (out of a plurality of sub-criteria) may be exposed to the second users.

In Step 307, the social-networking system determines whether a predetermined number of second users have issued submissions to fulfill the request issued by the first user. In Step 307, the social-networking system determines whether a predetermined number of second users have issued submissions to fulfill the request issued by the first user within a predetermined amount of time. According to one or more embodiments of the disclosure, the predetermined number of second users may be a number determined by the first user or may be a number set default by the social-networking system. Similarly, the predetermined amount of time may be a number determined by the first user or may be a number set default by the social-networking system. In one or more embodiments of the disclosure, the first user may initially not have the intention to set a predetermined number or a predetermined amount of time; however, the social-networking system may, upon determining that the request is time sensitive, prompt the first user to input a predetermined number or a predetermined amount of time. In prompting the first user to input a predetermined number or a predetermined amount of time, the social-networking system may pre-fill a predetermined number or a predetermined amount of time based on a historical usage rate. The historical usage rate may or may not be historical statistics relevant to the request. That is, the historical usage rate may or may not be historical data of social-networking users fulfilling the requests or requests that are substantially similar to the request issued by the first user. The historical usage rate may or may not be stored in the account module (221) of the server (215). In one or more embodiments, two requests may be substantially similar if, for example, a first request is set at 7:30 PM and a second request is set within a thirty minute timeframe of the first request. In one or more embodiments, two requests may be substantially similar if, for example, a first request is set at $500 and a second request is set within a +/−$100 range of the first request. In one or more embodiments, two requests may be substantially similar if, for example, a first request has the keyword “linear algebra” and a second request has the keyword “college algebra.” In one or more embodiments, two requests may be substantially similar if there are over a certain predetermined number and/or fraction of overlapped keywords. One of ordinary skill in the art would appreciate that the “substantially similar” threshold may be set and/or modified by the social-networking system, may be set and/or modified by the users of the social-networking system, etc. Further, one of ordinary skill in the art would appreciate that transactions involving greater sums may result in greater thresholds for meeting the definition of “substantially similar.” Specifically, whereas substantially similar in the case of $500 may be $400-$600 (having a range of $200), the case of $5,000 may be $3,500-$6,500 (having a range of $3,000).

In Step 307, if the social-networking system did not receive a predetermined number of second users within a predetermined amount of time to issue submissions to fulfill the request of the first user, the social-networking system may return to Step 303 and prompt the first user to modify certain parameters or issue a new request. The first user may be prompted in a similar manner as that discussed above in reference to Step 303. Otherwise, based on the first user's preference, the flowchart may end.

In Step 307, if the social-networking system did receive a predetermined number of fill requests from the second users in a predetermined amount of time, the flowchart may continue onto Step 309.

In Step 309, the social-networking system determines whether a second round of filtering, on top of the filtering by the first criterion/criteria, is requested by the first user. If the social-networking system determines that the second round of filtering has been requested by the first user, the flowchart moves onto Step 401. If the social-networking system determines that the second round of filtering has not been requested by the first user the flowchart may continue onto Step 311.

In Step 311, a first first sub-criterion may be used to filter which of the second users meet the demands of the request. However, a second first sub-criterion may then be subsequently used to filter those second users who meet the first first sub-criterion. The specific method for filtering and sorting the other users may or may not be carried out automatically (i.e. without first user interference). A layered filtering system (i.e. a plurality of filters of different requirements) may be applied to reduce the number of qualifying other users to a predetermined number. As discussed above, the predetermined number may be determined by the first user, may be suggested by the social-networking system, and/or may be pre-filled by the social-networking system. The second users that have been eliminated by any of the filters may be stored in the account module (221). The social-networking system may store the eliminated second users in different priorities based on how closely each of the eliminated second users are aligned with the request issued by the first user. That is, a second user who was eliminated by a second filter that is applied after a first filter will have a higher priority than a second user who was eliminated by the first filter. Note that the score is a relationship value between each of the plurality of the second users and the first user. The storing may append a relationship score between first the user and the eliminated second user. The score may or may not help prioritize the eliminated second user's placement in the account module (221) of the first user. The score may or may not be for a particular category of request that is associated with the first request, the second request, etc. In the future, when the first user issues a similar request to the initial request causing the storing, the prioritization information may be utilized to issue requests, recommendations, advertisements, etc., directly to those second users who have high prioritization scores compared to those who do not.

In one or more embodiments, the layered filtering system may retrieve key terms in the request and utilize a look-up table to determine whether the request is stored in a request module and/or request repository. The request module and/or request repository store common tasks and associate the tasks with certain related terms. For example, the request module and/or the request repository may archive the request “mathematics tutoring.” The request “mathematics tutoring” may be associated with keywords including “professor,” “college,” “mathematics,” “library,” “multivariable calculus,” etc. Upon detecting that the first user has submitted any criterion/criteria comprising the term “mathematics tutoring,” second users whose profiles comprise the terms, e.g., “professor,” “college,” “mathematics,” “library,” etc. may be given a higher relationship score (explained elsewhere in the specification). The request module and/or the request repository may be utilized as filter in the first criterion/criteria (i.e. first sub-criterion, second sub-criterion, etc.). For example, if the user submits any criterion/criteria comprising the term “mathematics tutoring” and elects to only view 20 second user profiles, and assuming that there are 15 qualifying second users whose profiles comprise the term “professor” and the term “mathematics,” 7 qualifying second users whose profiles only comprise the term “mathematics,” and 20 qualifying second users whose profiles only comprise the term “professor,” depending on the setting of the first user, the 15 qualifying second users whose profiles comprise the term “professor” and the term “mathematics” and 5 of the 7 qualifying second users whose profiles only comprise the term “mathematics” are displayed to the first user. In one or more embodiments, the terms may be ranked differently. For instance, in the case where the term “professor” is ranked higher than the term “mathematics,” the 15 qualifying second users whose profiles comprise the term “professor” and the term “mathematics” and 5 of the 20 qualifying second users whose profiles only comprise the term “professor” are displayed to the first user. The method for determining which of the 5 of the 7 qualifying second users are displayed to the first user can be various. For example, in one or more embodiments, 5 of the 7 qualifying second users are picked based on their distance away from the first user. For example, in one or more embodiments, 5 of the 7 qualifying second user profiles comprise additional terms that are stored in the request module and/or request repository that relate to the request “mathematics tutoring.” For example, 5 of the 7 qualifying second user profiles that are displayed to the first user comprise the term “multivariable calculus,” etc.

In Step 313, profiles of the second users that have not been eliminated by the first criterion/criteria (i.e. first sub-criterion, second sub-criterion, etc.) are now accessible/visible to the first user. The first user may or may not be given an option to store the visible profiles based on his or her preference. The stored visible profiles may be stored in a shortcut or in a favorite list for easy access in the near future. In one or more embodiments of the disclosure, the accessibility/privacy of the profiles of each user may be set by the respective users. Accordingly, it may be that the second user profiles are already visible to the first user before Step 313.

In Step 313, the visible profiles may display information, including, for example, name, age, gender, educational attainment, language, race, hourly rate, skill set, annual income, location, amount of time to run 100 meter, user social-networking system rating, etc. In the case where the visible profiles belong to an organization, the visible profiles may display information, including, for example, the size of the organization, the nature of the organization (industry), length of time as the organization, location of the organization, etc. In the case where the visible profiles belong to an asset, the visible profiles may display information, including, for example, the size of a room, the number of office buildings available, the number of parking spaces available, the availability of a private jet for the next month, etc.

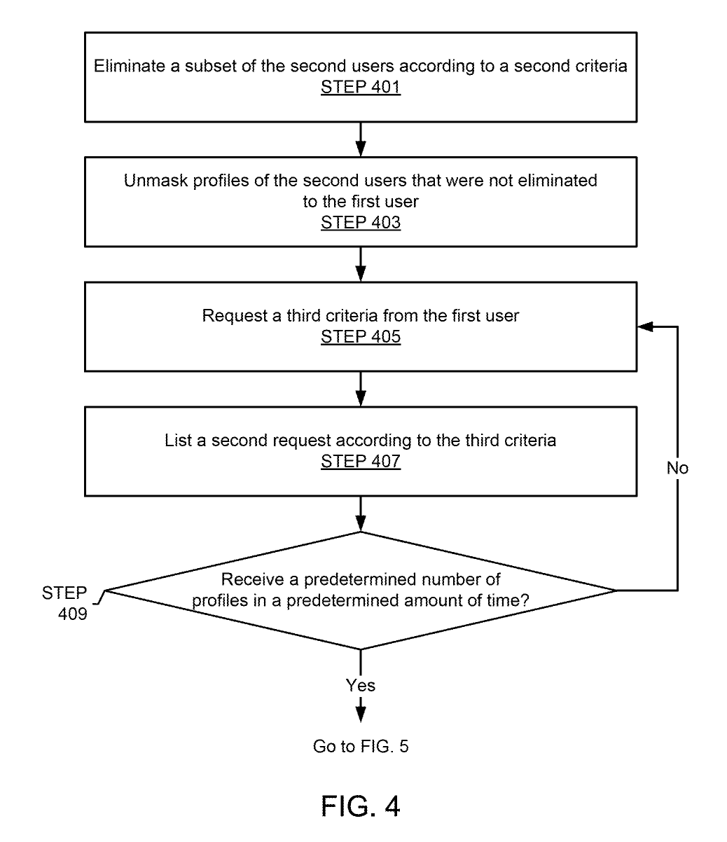

FIG. 4 shows a method for matching in a social-networking system according to one or more embodiments. The method shown in FIG. 4 may be implemented by the server (215). The method shown in FIG. 4 may or may not be implemented in combination with the method shown in FIG. 3.

In Step 401 a first first sub-criterion may be used to filter which of the second users meet the demands of the request. However, a second first sub-criterion may then be subsequently used to filter those second users who meet the first first sub-criterion. The specific method for filtering and sorting the other users may or may not be carried out automatically (i.e. without user interference). A layered filtering system (i.e. a plurality of filters of different requirements) may be applied to reduce the number of qualifying second users to a predetermined number. As discussed above, the predetermined number may be determined by the first user, may be suggested by the social-networking system, and/or may be pre-filled by the social-networking system. The second users that have been eliminated by any of the filters may be stored in the account module (221). The social-networking system may store the eliminated second users in different priorities based on how closely each of the eliminated second users are aligned with the request issued by the first user. That is, a second user who was eliminated by a second filter that is applied after a first filter will have a higher priority than a second user who was eliminated by the first filter. The storing may append a relationship score between the first user and the eliminated second user. The score may or may not help prioritize the eliminated second user's placement in the account module (221) of the first user. In the future, when the first user issues a similar request to the initial request causing the storing, the prioritization information may be utilized to issue requests directly to those second users who have high prioritization scores compared to those who do not.

In Step 403, profiles of the second users that have not been eliminated by the first criterion/criteria (i.e. first first sub-criterion, second first sub-criterion, etc.) are now accessible/visible to the user. The first user may or may not be given an option to store the visible profiles based on his or her preference. The stored visible profiles may be stored in a shortcut or in a favorite list for easy access in the near future.

In Step 403, the visible profiles may display information, including, for example, name, age, gender, educational attainment, language, race, hourly rate, skill set, annual income, location, amount of time to run 100 meters, user social-networking system rating, etc. In the case where the visible profiles belong to an organization, the visible profiles may display information, including, for example, the size of the organization, the nature of the organization (industry), length of time as the organization, location of the organization, etc. In the case where the visible profiles belong to an asset, the visible profiles may display information, including, for example, the size of a room, the number of office buildings available, the number of parking spaces available, the availability of a private jet for the next month, etc.

In Step 405, the first user using the social-networking system may submit or may be requested to submit second criterion/criteria. The submission may be in the form of strings, numbers, checkboxes, multimedia uploads, etc. The submission may be chosen from a list of requests already put together by the social-networking system. The second criterion/criteria may or may not be the same the first criterion/criteria.

In Step 407, the social-networking system assesses the validity of the request and, if the request is valid, lists a request according to the second criterion/criteria to the remaining second users. If the request is invalid, or if certain parameters of the request ought to be amended, the social-networking system may attempt to correct or prompt the first user to correct the request. If the first user lists a set of second criteria in Step 405, the listing in Step 407 may or may not list each and every one of the second criteria to the remaining second users who have remained after the first criterion/criteria. Instead, a first sub-criterion of the second criteria (out of a plurality of sub-criteria) may be exposed to the remaining second users.

In Step 409, the social-networking system determines whether a predetermined number of the remaining second users have issued submissions to fulfill the request issued by the first user in Step 405. In Step 409, the social-networking system determines whether a predetermined number of second users have issued submissions to fulfill the request issued by the first user within a predetermined amount of time. According to one or more embodiments of the disclosure, the predetermined number of second users may be a number determined by the first user or may be a number set default by the social-networking system. Similarly, the predetermined amount of time may be a number determined by the first user or may be a number set default by the social-networking system. In one or more embodiments of the disclosure, the first user may initially not have the intention to set a predetermined number or a predetermined amount of time; however, the social-networking system may, upon determining that the second request is time sensitive, prompt the first user to input a predetermined number or a predetermined amount of time. In prompting the first user to input a predetermined number or a predetermined amount of time, the social-networking system may pre-fill a predetermined number or a predetermined amount of time based on a historical usage rate. The historical usage rate may or may not be historical statistics relevant to the request. That is, the historical usage rate may or may not be historical data of social-networking users fulfilling the requests or requests that are substantially similar to the request issued by the first user. The historical usage rate may or may not be stored in the account module (221) of the server (215).

In Step 409, if the social-networking system did not receive a predetermined number of second users, the social-networking system may return to Step 405 and prompt the first user to modify certain parameters or issue a new request. The first user may be prompted in a similar manner as that discussed above in reference to Step 303 and Step 405. According to one or more embodiments of the disclosure, if the social-networking system did not receive a predetermined number of second user fill requests in a predetermined amount of time in Step 409, the chat room module 231 may initiate a chat room having the user and the remaining second users. Otherwise, based on the first user's preference, the flowchart may end.

In Step 409, if the social-networking system did receive a predetermined number of second user fill requests in a predetermined amount of time, the flowchart may continue onto Step 501.

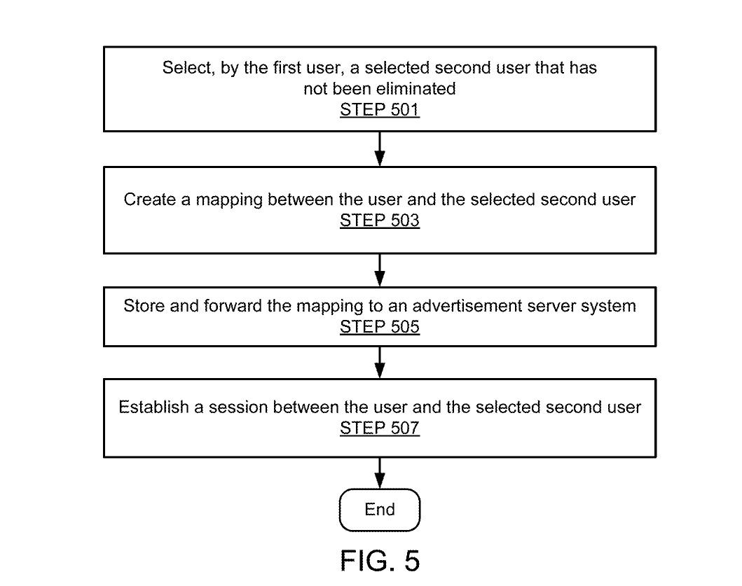

FIG. 5 shows a method for matching in a social-networking system according to one or more embodiments. The method shown in FIG. 5 may be implemented by the server (215). The method shown in FIG. 5 may or may not be implemented in combination with the method shown in FIG. 3 and the method shown in FIG. 4.

In Step 501, the first user of the social-networking system may select, from a pool of the remaining second users, a selected second user. In Step 501, second user(s) who is/are not the selected second user(s) may be assigned scores. The assigned scores may be higher than those of second users who were eliminated by the first criterion/criteria and/or the second criterion/criterion and/or the first filter, etc. The assigned scores may be stored in the storing. The score may or may not help prioritize the eliminated second user's placement in the account module (221) of the first user. In the future, when the first user issues a similar request to the initial request causing the storing, the prioritization information may be utilized to issue requests directly to those second users who have high prioritization scores compared to those who do not.

In Step 503, a mapping may be connected to bridge a profile of the first user to a profile of the selected second user. The mapping may be stored in a mapping module (not shown) of the server (215). In Step 501, the selected second user is assigned a score higher than those of second users who were eliminated by the first criterion/criteria and/or the second criterion/criterion and/or the first filter, etc. The score is also higher than that of second users who were not selected in Step 501. The assigned score may be stored in the storing. The score may or may not help prioritize the selected second user's placement in the account module (221) of the first user. In the future, when the first user issues a similar request to the initial request causing the storing, the prioritization information may be utilized to issue requests directly to those second users (including the selected second user) who have high prioritization scores compared to those who do not.

In Step 507, the mapping between the first user and the selected second user is stored. The mapping may be forwarded to the advertisement server system (107). Using the mapping, the advertisement server system (107) may, for example, serve advertisements of third users having similar attributes as the selected second user to the first user, and vice versa. Using the mapping, the advertisement server system (107) may, for example, serve advertisements of fourth users having similar attributes as the first user to the selected second user, and vice versa. Using the mapping, the advertisement server system (107) may, for example, serve advertisements of third users having similar attributes as the selected second user to fourth users having similar attributes as the first user, and vice versa. Using the mapping, the advertisement server system (107) may, for example, serve advertisements of fourth users having similar attributes as the first user to third users having similar attributes as the selected second user to the third users, and vice versa.

FIG. 6 shows a method for initiating a social-networking session in a social-networking system according to one or more embodiments. The method shown in FIG. 6 may be implemented by the server (215). The method shown in FIG. 6 may or may not be implemented in combination with the method shown in FIG. 3, the method shown in FIG. 4, and the method shown in FIG. 5.

In Step 601, a location of the computing device (101A) of the first user of the social-networking system is detected. The location may be acquired by any known protocol. For example, when a location of the user is to be obtained, a Location Service Client (LSC) may transmit a location service request carrying a user bearer identifier of the user to a Bearer Mapping Function (BMF) through a Gateway Mobile Location Centre (GMLC). After receiving the location service request, the BMF may search for a corresponding Interworking Packet Access Gateway (iPAG) according to the user bearer identifier, and after obtaining user location information from the iPAG, the BMF may return the user location information to the LSC through the GMLC or may instruct the GMLC to obtain the user location information from the iPAG.

In Step 603, a location of the computing device (101N) of the selected second user of the social-networking system is detected. The location may be acquired by any known protocol. For example, when a location of the user is to be obtained, a Location Service Client (LSC) may transmit a location service request carrying a user bearer identifier of the user to a Bearer Mapping Function (BMF) through a Gateway Mobile Location Centre (GMLC). After receiving the location service request, the BMF may search for a corresponding Interworking Packet Access Gateway (iPAG) according to the user bearer identifier, and after obtaining user location information from the iPAG, the BMF may return the user location information to the LSC through the GMLC or may instruct the GMLC to obtain the user location information from the iPAG.

In Step 605, a distance between the location of the computing device (101A) and the location of the computing device (101N) is computed. And if the distance is within a predetermined distance, the flowchart proceeds to Step 607. The predetermined distance may be specified by the first user. However, the disclosure is not limited to this. As discussed above, the predetermined distance may be set by the social-networking system, may be hidden from the first user and the selected second user, and/or may be set by the selected second user.

In Step 605, if the distance is not within a predetermined distance, the social-networking system may recompute the distance to check whether the distance falls within a predetermined distance every certain time interval or when certain condition is met (e.g., recompute every 5 minutes, recompute every 10 minutes, recompute upon detection of IP address change, etc.). In one or more embodiments of the disclosure, if the distance is not within a predetermined distance, the flowchart ends. In one or more embodiments of the disclosure, if the distance is not within a predetermined distance, an automatic mode of the social-networking system is converted to a manual mode. The automatic mode of the social-networking system, for example, recomputes the distance automatically without user interference. The manual mode of the social-networking system, for example, recomputes the distance only upon receipt of instruction from the user.

In Step 607, an electronic agreement comprising the first user's first criterion/criteria, second criterion/criteria, etc., or a combination thereof, is displayed to the computing device (101N) of the selected second user. The electronic agreement may further comprise laws governing the location of the first user, laws governing the location of the selected second user, rights and responsibilities binding the social-networking system, as well as any other information pertinent to the transaction between the first user and the selected second user.

In Step 609, the social-networking system determines whether the electronic agreement of Step 607 was agreed upon by the computing device (101N) of the selected second user. In one or more embodiments of the disclosure, the social-networking system may also determine whether the electronic agreement of Step 607 was agreed upon by the computing device (101A) of the first user. If either party, or if the selected second user, fails to accept the electronic agreement, the social-networking system may prompt the first user to modify the terms and conditions in the electronic agreement. In one or more embodiments of the disclosure, no modification that would result in failure of the selected second user to meet the first criterion/criteria, second criterion/criteria, etc. as specified in Step 305, Step 311, and/or Step 405 is permitted. In one or more embodiments of the disclosure, if either party, or if the selected second user, fails to accept the electronic agreement, the flowchart ends and the first user's first request is redisplayed to other second users on the social-networking system. In one or more embodiments of the disclosure, if either party, or if the selected second user, fails to accept the electronic agreement, the flowchart ends and all of the first user's requests in a single request session is redisplayed to other second users on the social-networking system. In one or more embodiments of the disclosure, if either party, or if the selected second user, fails to accept the electronic agreement, the flowchart ends.

In Step 609, if the social-networking system determines that the selected second user and/or the first user has accepted the electronic agreement, the flowchart continues onto Step 611.

In Step 611, a session between the first user and the selected second user having the selected profile is established.

Upon termination of the session, the monetization repository (207) of the application (103A) and/or the monetization module (227) of the server (215) may send an invoice to the first user for the services and/or goods provided by the selected second user. The monetization repository (207) and/or the monetization module (227) may in turn collect a fee and pass the remaining amount to the selected second user using any known transaction method (see discussion in reference to the payment module and/or the payment repository).

However, the method described above in reference to FIG. 6 is not limited so. For instance, the method may additionally comprise a step of terminating a session. The session may be terminated manually or may be terminated automatically after a predetermined amount of time has lapsed.

For instance, the method may initiate a session between the first user and the selected second user when the first user manually initiates a session. In this example, Step 601, Step 603, and/or Step 605 may be omitted.

For instance, the method may initiate a session between the first user and the selected second user by a third-party unrelated to the first user and the selected second user.

For instance, the method may initiate a session between the first user and the selected second user without executing Step 607 and/or Step 609.

FIG. 7 shows a method for initiating a social-network session in a social-networking system according to one or more embodiments. The method shown in FIG. 7 may be implemented by the server (215). The method shown in FIG. 7 may or may not be implemented in combination with the method shown in FIG. 3, the method shown in FIG. 4, the method shown in FIG. 5, and the method shown in FIG. 6.

In Step 701, the first user using the social-networking system may submit or may be requested to submit a first criterion/criteria. The submission may be in the form of strings, numbers, checkboxes, multimedia uploads, etc. The submission may be chosen from a list of requests already put together by the social-networking system.

In Step 703, the first user may identify, in the chat room repository, contacts (i.e., second users) that the first user wish to forward the first criterion/criteria to. According to one or more embodiments, the contacts already have mappings with the first user. According to one or more embodiments, the contacts may not be second users that the first user has previously contacted.

In Step 705, the social-networking system determines whether the first criteria/criterion was accepted by a predetermined number of the contacts within a predetermined amount of time.

According to one or more embodiments of the disclosure, the predetermined number of users may be a number determined by the user or may be a number set default by the social-networking system. Similarly, the predetermined amount of time may be a number determined by the first user or may be a number set default by the social-networking system. In one or more embodiments of the disclosure, the first user may initially not have the intention to set a predetermined number or a predetermined amount of time; however, the social-networking system may, upon determining that the first criterion/criteria is time sensitive, prompt the first user to input a predetermined number or a predetermined amount of time. In prompting the first user to input a predetermined number or a predetermined amount of time, the social-networking system may pre-fill a predetermined number or a predetermined amount of time based on a historical usage rate. The historical usage rate may or may not be historical statistics relevant to the request. That is, the historical usage rate may or may not be historical data of social-networking users fulfilling the first criteria/criterion that is/are substantially similar to the first criteria/criterion issued by the first user. The historical usage rate may or may not be stored in the account module (221) of the server (215).

In Step 705, if the social-networking system did not receive a predetermined number of second users, the social-networking system may return to Step 701 and prompt the first user to modify certain parameters or issue a new request. The first user may be prompted in a similar manner as that discussed above in reference to Step 303, Step 405, and Step 409. According to one or more embodiments of the disclosure, if the social-networking system did not receive a predetermined number of second user fill requests in a predetermined amount of time in Step 705, the chat room module 231 may initiate a chat room having the contacts. Otherwise, based on the first user's preference, the flowchart may end.

In Step 705, if the social-networking system did receive a predetermined number of second user fill requests in a predetermined amount of time, the flowchart may continue onto Step 707.

In Step 707, a chat room having the contacts (the second users) and the first user is created. The first user is designated as a moderator and the second users are designated as the participants. The rights and privileges of the moderator and the participant(s) may or may not be the same.

In Step 709, the first user using the social-networking system may submit or may be requested to submit a second criterion/criteria, which may not be the same as the first criterion/criteria. The submission may be in the form of strings, numbers, checkboxes, multimedia uploads, etc. The submission may be chosen from a list of requests already put together by the social-networking system.

After the submission of the second criterion/criteria by the first user, the second criterion/criteria may be subject to the same examination as that specified in Step 705.

In Step 711, profiles of the second users who wish to fill the second criterion/criteria are displayed to the first user. As discussed above, based on the settings of the second users, the profiles of the second users may or may not already be visible to the first user before Step 711.

In between Step 711 and Step 713, the first user selects a selected second user from the second users who wish to fill the second criterion/criteria.

In Step 713, a session between the first user and the selected second user may be initiated. The session may be initiated in a similar manner as that to that already described in reference to FIG. 6.

Upon termination of the session, the monetization repository (207) of the application (103A) and/or the monetization module (227) of the server (215) may send an invoice to the first user for the services and/or goods provided by the second user. The monetization repository (207) and/or the monetization module (227) may in turn collect a fee and pass the remaining amount to the selected second user using any known transaction method.

### Example 1: Open One Criteria/Criterion Bid

Consider a scenario in which Kevin utilizes a computing device (101A) executing a social-networking application (103A) and inputs a first criteria. The first criteria being “tutoring help with linear algebra”+“under $30/hour”+“location within zip 77010”+“educational attainment: bachelor's degree.” The criteria being listed in the order of importance to Kevin. A first request having the first criteria is listed in an interactive page of the social-networking application (103A) client (122) of the social-networking system. However, second users who observe the first request by Kevin may only see the first first criterion “tutoring help with linear algebra” and the second first criterion “under $30/hour.”

Assuming Kevin does not set a maximum number of qualifying second users requests to receive, the social-networking system may limit the number of qualifying second user bids to Kevin's request to 30. However, it may be the case that over 100 second users bid to fill the first request by Kevin (i.e., more than 100 second users bid to help fulfill Kevin's first request). The bid setting module (229) of the social-networking system may eliminate excess second user bids based on third first criterion “location within zip 77010” and fourth first criterion “education attainment,” which are not shown to the second users.

If there are still more than 30 users upon applying the third first criterion and the fourth first criterion, the social-networking system may display the 30 users having the lowest hourly rate, which is a quantifiable criterion (we, of course, know that all these 30 second users also comprise the term “linear algebra” in their respective profiles.). In the event that the second user submitting the 26^{th} lowest hourly rate ties with second users submitting the 27^{th}-32^{nd} lowest hourly rate (e.g., $22.42), other attributes among these 7 second users may be compared, depending on the prioritization of certain qualities, to arrive at a pool of 30 second users. The profiles of the 30 second users are now unveiled to Kevin and Kevin is able to freely choose from among the 30 second users to hire.

### Example 2: Open Plural Criteria/Criterion Bid

Consider a scenario in which Kevin utilizes a computing device (101A) executing a social-networking application (103A) and inputs a first criteria. The first criteria being “tutoring help with linear algebra”+“under $30/hour”+“location within zip 77010”+“educational attainment: bachelor's degree.” The criteria being listed in the order of importance to Kevin. A first request having the first criteria is listed in an interactive page of the social-networking application (103A) client of the social-networking system. However, second users who observe the first request by Kevin may only see the first first criterion “tutoring help with linear algebra” and the second first criterion “under $30/hour.”

Assuming Kevin does not set a maximum number of qualifying second user requests to receive and Kevin receives 292 second user bids to fill the first request by Kevin (i.e., 292 second users bid to help fulfill Kevin's first request). The bid setting module (229) of the social-networking system may eliminate excess second user bids based on third first criterion “location within zip 77010” and fourth first criterion “education attainment,” which are not shown to the second users.

If there are still too many second users upon applying the third first criterion and the fourth first criterion, or if Kevin indicated a second round of bidding, Kevin may subsequently issue a second criteria. The second criteria being “numerical input: number of years having tutored linear algebra”+“under $25/hour”+“weekly availability: Monday and Wednesday evenings from 7:00 PM-9:0 PM”+“multimedia input: resume upload,” etc.

As with the first criteria, the second users may or may not see all of the second criteria. A second request having the second criteria is sent to the 292 second users who elected to fill Kevin's first request. Assuming that only 142 second users elect to fill Kevin's second request, a filter may be subsequently introduced to minimize the number of second users displayed to Kevin in a similar fashion as that explained in Example 1. Assuming that only 30 second users remain, either by automatic filtering or by manual filtering, the profiles of the 30 second users are unveiled to Kevin and Kevin is able to freely choose from among the 30 second users to hire.

### Example 3: Closed Chat Room Bid

Consider a scenario in which Kevin utilizes a computing device (101A) executing a social-networking application (103A) and inputs a first criteria. The first criteria being “Availability: this coming Friday 9:00 PM to 11:00 PM”+“DJ”+“house music.” The criteria being listed in the order of importance to Kevin. A first request having the first criteria is issued to contacts of Kevin who are on the social-networking system. Kevin issues the request to 30 contacts who Kevin thinks are qualified. If no contact fills the first request, or if there is not a minimum of, for example, five contacts who fill the first request, Kevin is prompted by the social-networking system to modify the first criteria. Assuming that Kevin modifies the first criteria. The modified first criteria being “Availability: this coming Friday 9:00 PM to 11:00 PM”+“DJ.” Assume that Kevin now receives fill requests from his contacts Adam, Brooke, Cathy, Daniel, Eric, Fiona, George, Haley, Ian, and Jessie, a chat room comprising Kevin as moderator and Adam, Brooke, Cathy, Daniel, Eric, Fiona, George, Haley, Ian, and Jessie as participants is created.

Discussions may take place within the chat room before a second criteria is input by Kevin. Kevin then inputs or is prompted to input a second criteria. The second criteria being “Cost below $400.” A second request having the second criteria is now forwarded to Adam, Brooke, Cathy, Daniel, Eric, Fiona, George, Haley, Ian, and Jessie. Adam, Brooke, Cathy, Daniel, Eric, Fiona, George, Haley, Ian, and Jessie may or may not see what each other bids. Further, not all of Adam, Brooke, Cathy, Daniel, Eric, Fiona, George, Haley, Ian, and Jessie may decide to place a fill request for the second request. In one or more embodiments, if Kevin issues the first request as “Cost below $300,” Kevin is not allowed to input a second request “Cost below $400.” That is, in one or more embodiments, the “scope” of a later-applied filter cannot be broader than that of an earlier-applied filter.

Now assume that only Eric and Jessie remain. Kevin may then choose to hire between Eric and Jessie.

### Example 4: Smart Advertisement/Recommendation 1

Consider a scenario in which a mapping module and/or a mapping repository of the social-networking system has a mapping between Kevin and Jessie (assuming that Kevin ultimately picks Jessie over Eric in Example 3). Now further assume in the scenario that a third user—Lynn—submits a request having criteria substantially similar to or identical to Kevin's request, i.e., “DJ”+“Friday”+“Cost below $350.” Lynn's client (211) may be fed with advertisements of individuals having similar characteristics as Jessie (perhaps even include Jessie) from the advertisement server system (107). These individuals have been identified to have performed/filled similar requests as the request of Kevin in Example 3. Lynn can engage those users by serving requests directly to those users or Lynn can engage those users by requesting that her request be sent to those users' request listing.

### Example 5: Smart Advertisement/Recommendation 2

Consider a scenario in which a mapping module and/or a mapping repository of the social-networking system has a mapping between Kevin and Jessie (assuming that Kevin ultimately picks Jessie over Eric in Example 3). Now further assume in the scenario that a third user—Lynn—submits a request having criteria substantially similar to or identical to Kevin's request, i.e., “DJ”+“Friday”+“Cost below $350. ” Mark, and those whose profile have been deemed by the social-networking system to be substantially similar to that of Jessie, may be fed with advertisements and/or recommendations to fill Lynn's request. Mark can then engage Lynn by filling Lynn's request directly by clicking on the advertisement and/or the recommendation.

### Example 6: Smart Advertisement/Recommendation 3

Consider a scenario in which a mapping module and/or a mapping repository of the social-networking system has a mapping between Kevin and Jessie (assuming that Kevin ultimately picks Jessie over Eric in Example 3). Now further consider that Kevin issues a request substantially similar to or identical to Kevin's request in Example 3. Jessie may be informed by the discovery module/repository and/or the recommendation module/repository that Kevin is making a request that she has filled or can fill. The social-networking system may recommend that Jessie fill Kevin's request.

### Example 7: Smart Advertisement/Recommendation 4

Consider a scenario in which a mapping module and/or a mapping repository of the social-networking system has a mapping between Kevin and Jessie (assuming that Kevin ultimately picks Jessie over Eric in Example 3). Now further consider that Kevin issues a request substantially similar to or identical to Kevin's request in Example 3. Kevin may be prompted by the social-networking system to, depending on Jessie's setting, directly prompt Jessie to submit a bid for Kevin's request.

### Example 8: Initiating a Social-Networking Session & Monetization

Consider a scenario in which Kevin utilizes a computing device (101A) executing a social-networking application (103A) and inputs a first criteria. The first criteria being “I need 3 movers to help me move from address A to address B.” Ultimately, using the social-networking system, Mandy, Nicole, and Orlando become the three selected users. Mappings between Kevin and Mandy, between Kevin and Nicole, and between Kevin and Orlando are created.

In one or more embodiments, when Mandy, Nicole, and Orlando are within a predetermined distance of Kevin, an electronic agreement is populated on the client (211) of Mandy, Nicole, and Orlando. The electronic agreement may be populated to Mandy, Nicole, and Orlando when all three are within a predetermined distance of Kevin. The electronic agreement may be populated to Mandy, Nicole, and Orlando when the social-networking system detects that the three are within are predetermined distance of address A. In one or more embodiments, the electronic agreement may be populated to each of Mandy, Nicole, and Orlando as each of the three selected users come within a predetermined distance of Kevin and/or address A. In one or more embodiments, Kevin may be physically away from address A and initiate the electronic agreement manually, i.e., without location detect of any user.

When the electronic agreement has been signed by Mandy, Nicole, and Orlando, a timer may initiate, or, if the moving is to be completed with the payment being a predetermined lump-sum, e.g. $300 per person, a social-networking session may be established between Mandy and Kevin, between Nicole and Kevin, and between Orlando and Kevin.

Any of the involved parties may terminate the session and/or the timer at any time. For example, if Orlando is to charge at an hourly rate of $50 and Orlando terminates the task prematurely (before Kevin indicates that the request is filled), Orlando is paid for the amount of time he spent helping Kevin. If Orlando spends 90 minutes, Orlando will charge Kevin $75. If Orlando terminates the task prematurely, and a lump-sum is elected to be the payment option, the amount that Kevin is charged is in accordance to the electronic agreement, which may specify that Kevin does not have to pay anything if a hired individual terminates prematurely. In one or more embodiments, the hired individual may be paid at a discounted rate for terminating prematurely. In one or more embodiments, the amount charged to Kevin may be determined by a predetermined formula according to the social-networking system. The predetermined formula may be computed based on historical data, etc. Likewise, if Kevin decides to terminate prematurely, he may be required to pay Mandy, Nicole, and Orlando for their time spent on the request. Further, in one or more embodiments, depending on the electronic agreement, Kevin may be required to pay an early termination fee. If Mandy and Nicole complete Kevin's request, the social-networking session is terminated. Kevin is subsequently charged by Mandy and Nicole according to their respective electronic agreements and/or bid criteria with Kevin. As discussed above, payment may be made using the payment module and/or the payment repository. In one or more embodiments, the payment mechanism may be completely separate from the social-networking system. In one or more embodiments, the payment mechanism is an SDK embedded in the application (103A). In one or more embodiments, under no condition will Mandy, Nicole, and Orlando fail to meet the criteria of the request. For example, if Kevin specified in the bidding process “$100 an hour,” no individual will be paid more than $100 an hour. Alternative, known methods are implemented to ensure fair bidding, pricing, etc. Further, no requests against the law may be made. For example, if Kevin requests a particular service from an individual in Florida for $2.50, which is below the state's minimum wage, the request will not be listed on the social-networking system. In one or more embodiments, if Kevin repeatedly submits invalid requests, he may be placed in the blacklist module and/or blacklist repository of the social-networking system. If Kevin repeatedly places requests, but repeatedly terminates early, he may be placed in the blacklist module and/or blacklist repository of the social-networking system.

While the disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered as examples because many other architectures can be implemented to achieve the same functionality.

The process parameters and sequence of steps described and/or illustrated herein are given by way of example only. For example, while the steps illustrated and/or described herein may be shown or discussed in a particular order, these steps do not necessarily need to be performed in the order illustrated or discussed. The various example methods described and/or illustrated herein may also omit one or more of the steps described or illustrated herein or include additional steps in addition to those disclosed.

While the disclosure has been described with respect to a limited number of embodiments, those skilled in the art, having benefit of this disclosure, will appreciate that other embodiments can be devised which do not depart from the scope of the disclosure as disclosed herein.

Furthermore, one of ordinary skill in the art would appreciate that certain “units,” “criteria,” “requests,” “profiles,” “bids,” “mappings,” “repositories,” “modules,” “systems,” “networks,” “parts,” “elements,” “clients,” or “portions” of one or more embodiments of the present disclosure may be implemented by a circuit, processor, etc., using any known methods. Accordingly, the scope of the disclosure should be limited only by the attached claims.

1-20. (canceled)

21. A communication system comprising:
a base station apparatus comprising a processor, the base station apparatus is operatively connected to a Location Service Client (LSC) that identifies a location of the base station apparatus;
a first mobile station; and
a second mobile station having an Internet Protocol location (IP location),
wherein the processor is configured to:
obtain, from the first mobile station associated with a first social-networking account, a request,
transmit the request to the second mobile station, the second mobile station is associated with a second social-networking account,
receive a bid from the second mobile station to fill the request,
detect that the location of the base station apparatus is not a location of the IP location and determine that the bid is an invalid bid, and
not transmit a user profile of the second social-networking account to the first mobile station.

22. The system according to claim 21, wherein the request includes at least one selected from a group consisting of: a résumé that includes an employment history, a gender requirement, a sexual orientation requirement, an educational attainment requirement, a language requirement, an hourly rate requirement, and a social-networking rating.

23-27. (canceled)

28. The system according to claim 21, wherein:
the first social-networking account and the second-networking account are linked on a first social-networking platform, and
the processor further transmits a blacklist message to the first mobile station that causes the first social-networking account to blacklist the second social-networking account on the first social-networking platform.

29. The system according to claim 28, wherein the processor is further configured to:
detect that the first social-networking account is linked to the second social-networking account on a second social-networking platform, and
alert the first mobile station that the first social-networking account is linked to the second social-networking account on the second social-networking platform.

30. A communication method of a first mobile station, a second mobile station having an Internet Protocol location (IP location), and a base station apparatus comprising a processor in which the base station apparatus is operatively connected to a Location Service Client (LSC) that identifies a location of the base station, the communication method comprising:
obtaining, by the processor, a request from the first mobile station associated with a first social-networking account;
transmitting, by the processor, the request to the second mobile station associated with a second social-networking account;
receiving, by the processor, a bid from the second mobile station to fill the request;
detecting that the location of the base station apparatus is not the IP location and determining that the bid is an invalid bid; and
not transmitting a user profile of the second social-networking account to the first mobile station.

31. The method according to claim 30, wherein the request includes at least one selected from a group consisting of: a résumé that includes an employment history, a gender requirement, a sexual orientation requirement, an educational attainment requirement, a language requirement, an hourly rate requirement, and a social-networking rating.

32-36. (canceled)

37. The method according to claim 30, wherein:
the first social-networking account and the second social-networking account are linked on a first social-networking platform, and
the method further comprises transmitting a blacklist message to the first mobile station that causes the first social-networking account to blacklist the second social-networking account on the first social-networking platform.

38. The method according to claim 37, wherein further comprising:
detecting that the first social-networking account is linked to the second social-networking account on a second social-networking platform, and
alerting the first mobile station that the first social-networking account is linked to second social-networking account on the second social-networking platform.

39. (canceled)

40. (canceled)

41. The system according to claim 21, wherein the processor is configured to transmit the user profile of the second social-networking account to the first mobile station if the first mobile station has whitelisted the second social-networking account.

42. The system according to claim 21, wherein the LSC identifies the location of the base station using a user bearer identifier and an Interworking Packet Access Gateway.
